(19) United States
(12) Patent Application Publication
(10) Pub. No.: US 2014/0277767 A1
(43) Pub. Date: Sep. 18, 2014

(54) TECHNIQUES FOR PROVIDING USER FEEDBACK IN A HEATING VENTILATION AIR-CONDITIONING (HVAC) SYSTEM

(71) Applicant: Abraham Othman, Oakland, CA (US)

(72) Inventor: Abraham Othman, Oakland, CA (US)

(21) Appl. No.: 13/802,285

(22) Filed: Mar. 13, 2013

(51) Int. Cl. G05D 23/19

(52) U.S. Cl. CPC G05D 23/1917
USPC 700/278

(57) ABSTRACT

In accordance with embodiments, there are provided techniques for operating an HVAC to provide substantially contemporaneous thermal feedback in response to a user varying a temperature set point of the system. This is achieved using an HVAC system of the type having a pump in fluid communication with both a supply of gas and a duct system, having an input and an output and defining a flow path therebetween, and a temperature regulation system in thermal communication with the flow path. A controller is in electrical communication with the temperature regulation system and the pump to regulate operation of the HVAC system.

### FIELD OF THE INVENTION

The current invention relates generally to heating ventilation air conditioning (HVAC) systems. More particularly the current invention relates to techniques for providing user feedback in HVAC systems.

### BACKGROUND

Heating, Ventilation, and Air Conditioning (HVAC) is the technology of indoor and automotive environmental comfort. HVAC system design is important to ensure the health and safety of occupants of a building. To that end, a typical HVAC system ensures proper regulation of atmosphere in an volume by introducing fresh air into the volume from a region exterior thereto and exhausting the atmosphere from the volume Proper regulation of the atmosphere includes adjusting the temperature, humidity and air pressure of the same. It stands to reason that three basic functions of any HVAC system are heating and cooling of a gas flow entering the volume, as well as and ventilating of the volume. These functions are interrelated to the goal for providing a comfortable environment intended for human habitation. Many of the fundamental principles to achieve these objectives were developed from the mid-Nineteenth Century to the early Twentieth Century by HVAC pioneers such as Reuben Trane and Willis Carrier relying upon the principles of physics discovered by the research activities of Michael Faraday, James Joule, Sadi Carnot and the like.

Now a relatively mature technology, recent development of HVAC systems has been directed to increasing the efficiency of the same: reducing energy consumed while maintaining a desired comfort level in a given volume of gas. To that end, many improvements of HVAC systems are directed to controllers. Thermostats are a fundamental controller for any HVAC system and operate to maintain atmospheric conditions at a desired set point. Typically, a thermostat switches between heating or cooling functions of the HVAC system to maintain the desired temperature. To that end, a thermostat includes a sensor to measure the temperature of the volume that is subject to regulation by the HVAC system and a user interface to allow establishing the desired set point.

Sensor technologies employed with thermostats varies greatly and includes mechanical sensors, such as the bimetallic sensors, and electrical sensors, such as electronic thermistors and semiconductor devices. Control of the HVAC system may be achieved through direct mechanical control, pneumatic signal or electrical signals. A common thermostat employed today operates on a low voltage, e.g. 24 volts AC. Typically referred to as a 24 Volt Thermostat (TVT), these are electrical thermostats that are typically programmable and control operation of an HVAC system using electrical signals. One advantage of the TVT is the flexibility provided by allowing control of multiple electromechanical switching devices.

Another advantage of TVT is its use in increasing the efficiency of the HVAC, which has become an important drive in technological development. It is estimated that the annual energy consumption of HVAC systems in commercial buildings in the United States is in excess of $105 billion dollars. This is approximately 10% of the value of the total rent paid for the commercial lease space. In addition, recent surveys have suggested that merely 30% of the workforce in commercial buildings are satisfied with the comfort of the atmosphere in their working environment. This decreases the productivity of the work force. Moreover these two factors can compounding each other in that as workers focus on improving the comfort of the atmosphere in the work environment the productivity decrease due to repeated interaction with HVAC thermostats. The repeated interaction with the HVAC thermostat leads to over utilization of the HVAC system thereby decreasing the inefficiency of the same, as well as degrading the comfort of the atmosphere in the working environment. Prior attempts have been made to ameliorate these conditions.

United States patent publication number 2013/0024799 to Fadell et al. discloses methods and devices for controlling a heating, ventilation, and air conditioning (HVAC) system by a thermostat. Input can be received from a user via a thermostat, the input being indicative of an adjustment of an HVAC-related setting. On a real-time basis, the HVAC-related setting that is being adjusted can be compared against a feedback criterion designed to indicate a circumstance under which feedback is to be presented to the user. The circumstance can be indicative of an achievement of a HVAC-related setting of a predetermined responsibility level with respect to an energy usage of the HVAC system. Upon a real-time determination that the feedback criterion is satisfied, visual feedback can be caused to be presented to the user in real-time. The real-time feedback can include a visual icon having a visual appeal corresponding to a desirability of the satisfaction of the feedback criterion.

United States patent publication number 2010/0063832 to Brown discloses an incentive allocation to a community of users based on thermostat settings. The users of the community establish user rules and thermostat settings directed to a climate-controlling device. The settings and rules are communicated to a central processor for calculating an incentive amount to allocate to each user. The calculated incentive amounts are based on the thermostat settings, energy consumption, and/or carbon emissions of the user. The incentives can also be calculated based on a comparison of a thermostat setting and a subsistence level. In an example, users of a multi-user development share a total amount of carbon credits given to the entire development. The carbon credits are distributed to each user based on the thermostat settings and carbon emission of each user.

Thus, there is a need to provide improved operational techniques of HVAC systems to reduce the interaction with the controls of the same.

### BRIEF SUMMARY

In accordance with embodiments, an HVAC system and a method of operating the same features providing thermal feedback to a user substantially contemporaneous with a change in desired set point temperature. This is achieved by providing gas to a volume at a temperature that is different than the desired set point temperature for a duration of time before returning the HVAC system to an operational mode to establish the temperature in a volume to be the desired set point temperature. To that end, an HVAC system includes a pump in fluid communication with both a supply of gas and a duct system, having an input and an output and defining a flow path therebetween. A temperature regulation system is in thermal communication with the flow path and a controller is in electrical communication with the temperature regulation system and the pump. The method includes receiving a request from the control system to establish in the volume a desired set point temperature; transmitting, with the controller, a temperature control signal to cause the temperature regulation system to vary a temperature of gas propagating toward the output to a pre-determined temperature set point that is different from the desired set point temperature, with the pre-determined temperature being independent of the magnitude of the desired set point temperature; and upon expiration of a pre-determined duration of time, establishing the temperature regulation system to transmitting with the controller a regulation signal to the temperature regulation system to establish the gas exiting the output to maintain a temperature in the volume proximate to the desired temperature set point. These and other embodiments are discussed in further detail below.

### BRIEF DESCRIPTION OF THE DRAWINGS

FIG. 1 is a simplified plan view of an HVAC system in accordance with the present invention;

FIG. 2 is a graph demonstrating different set point temperatures of the HVAC system shown in FIG. 1 over time;

FIG. 3 is a simplified plan view of a interface used in a control shown in FIG. 1, in accordance with the present invention;

FIG. 4 is a simplified plan view of the controller shown in FIG. 1 in accordance with the present invention;

FIG. 5 is flow diagram showing a method of operating the HVAC system shown in FIG. 1 in accordance with a first embodiment of the present invention; and

FIG. 6 is flow diagram showing a method of operating the HVAC system shown in FIG. 1 in accordance with a second embodiment of the present invention.

### DETAILED DESCRIPTION

Referring to FIG. 1 a heating ventilation air-conditioning (HVAC) system 10 is shown that includes a pump 12 in fluid communication with both a supply of gas 14, and a duct system 16, having an input 18 and an output 20 and defining a flow path 22 therebetween. A temperature regulation system includes a chilling unit 24 and a variable airflow volume (VAV) box 26 having a heating unit 28 disposed therein in thermal communication with flow path 22. A controller 30 is in electrical communication with the temperature regulation system and pump 12 to regulate operation of HVAC system 10. As is well known in the art controller 30 typically includes a sensor 32 that is in thermal communication with a volume 34 that is defined by walls 36 and is in fluid communication with output 20 to maintain gases in volume 34 at a desired temperature. To that end, controller 30 includes a user interface 38 by which a user may enter a request to establish a desired set point temperature. Traditionally, controller was disposed within volume 34, for example, mounted to one of walls 36; however, controller 30 is shown disposed outside of volume 34 for ease of discussion. It should be understood that the present invention encompasses both embodiments of the use of a traditional controller disposed in volume 34 and the current embodiment whereby at least a portion of controller 30 is disposed outside of volume. In this configuration sensor 32 includes a thermocouple 36 disposed in volume 34 and in electrical communication with controller 30. Gas is drawn from supply 14 via a vacuum and directed through outlet 20 through positive pressure. The vacuum and positive pressure is concurrently generated by pump 12. Although supply 14 is shown by an enclosure in practice supply is ambient air outside of volume 34, i.e., it is the atmosphere of the earth.

Referring to FIGS. 1 and 2 to establish a desired set point temperature in volume 34 a common control technique is referred to as on/off control. To that end, an upper threshold limit tᵤ and a lower threshold limit tₗ is established with controller 30. An ideal HVAC system 10 would result in the temperature of the gas in volume 34, shown by the slope of line 40, being maintained between tᵤ and tₗ during operation. In practice, however, the temperature of volume 34 is slightly above tᵤ, shown as δᵤ and slightly below tₗ, shown as δₗ. In operation, controller 30 regulates HVAC system to terminate heating of gas upon temperature tᵤ being reached and chilling of gas upon temperature tₗ being reached. In more sophisticated operates a combination of heating cooling and discharging gas at ambient temperatures into volume 34 may be employed to maintain the temperature of volume 34 at a desired set point temperatures. It is well accepted that maintaining a temperature to be between tᵤ and tₗ require less energy to be consumed than to reach a new set point temperature. Thus, when multiple adjustments to set point temperature are undertaken by one or more users in volume 34 the efficiency of HVAC system 10 is reduced. This may prove particularly problematic with HVAC systems in which the delay between establishing a set point temperature using with controller 30 and a perceived change in the temperatures of the gas in volume 34. Specifically, in the absence of feedback indicating to a user that the HVAC system is undertaking operation to reach a desired set point temperature, a user may repeatably use controller 30 to establish multiple desired set point temperatures before HVAC system has been provided sufficient tie to heat volume to 32 the desired set point temperature. This may result in unwanted cycling of HVAC system 10, reducing the operational life and efficiency of the system, as well renders the time of the user unproductive, in the case of a work environment.

Referring to both FIGS. 1 and 3, the instant invention seeks to avoid the aforementioned problem by avoiding the use of quantitative input by a user when establishing a new set point temperature and providing thermal feedback to a user contemporaneous with the user using controller 30 to establish a new set point temperature. Controller 30 is with a unique interface 40. In one example, controller 30, in accordance with the instant invention, is different from thermostats of the prior art by virtue of the user interface 40 do not include quantitative inputs, i.e., no numeric input is provided. Rather, the settings afforded by interface 40 are qualitative in nature. As can be seen three virtual input regions 41, 42 and 43 are displayed. Each VIR 41, 42 and 43 includes indicia that is different from the indicia associated with the remaining VIR 41, 42 and 43. In one example the indicia of VIR 41 recites “Warm this room up”. The indicia, of VIR 42 recites “I am comfortable”; and the indicia of VIR 43 recites “Cool this room down”: It is believed that by preventing a user employing quantitative-based requests for temperature settings HVAC system 10 may be used more efficiently. For example it was determined that okay opposed to a perceived quantitative perception of comfort, a user would be more inclined to accept the established set point temperature of HVAC system 10.

To provide a user of thermostat with the confidence that an desire set point temperature change was underway, controller 30 directs the pump 12 and the temperature regulation system to send a feedback gush of gas through output 20. To that end, controller 30 transmits a temperature control signal to temperature regulation system to vary a temperature of gas propagating along flow path 22 toward output 20. Were the desired set point temperature established to increase the temperature of gases in volume 34, the temperature regulation system would increase the temperature of the gases exiting output 20. To that end, controller 30 would transmit a temperature control signal to heating unit 28 to heat gas propagating along flow path to a pre-determined temperature. The predetermined temperature would be based upon several characteristics of the HVAC system 10 and the temperature of ambient supply of gas 14. The goal sought to be achieved, however, is to have gases exiting output 20 to have a requisite temperature so as to notify a user that the desired set point temperature entered was in the process of being achieved by HVAC system 10. On manner in which to achieve this would be to have heating unit 28 to operate at a maximum heating capacity for a duration of time to achieve the aforementioned goal while not unduly degrading the efficiency of HVAC system 10 and/or degrading the operational life of heating unit 28 and/or HVAC system 10.

In one example, heating unit 28 would heat gas propagating along flow path 22 toward output 20 to a temperature of 900 Fahrenheit. It should be understood that the temperature at the temperature regulation system varies the gas temperature is independent of the magnitude of the desired set point temperature. For example, the temperature of the gush of gas exiting output 20 would be set at the same regardless of whether the desired set point temperature result in only 1 degree in change of temperature currently measured in volume 34 or a ten degree change in temperature: Heating unit 28 would heat the gas to the desired temperature, in this example being 90° Fahrenheit.

Were the desired set point temperature to result in a decrease of the temperature of the gas in volume 34 the temperature control signal transmitted to the temperature regulation system would cause chilling unit 24 to decrease the temperature of gas propagating along flow path 22 toward output 20. The temperature regulation system would decrease the temperature to a pre-determined temperature that is based upon several characteristics of the HVAC system 10 and the temperature of ambient supply of gas 14. The goal sought to be achieved, as mentioned above, is to have gases exiting output 20 to have a requisite temperature so as to notify a user that the desired set point temperature entered was in the process of being achieved by HVAC system 10. On manner in which to achieve this would be to have chilling unit 24 to operate at a maximum cooling capacity for a duration of time to achieve the aforementioned goal while not unduly degrading the efficiency of HVAC system 10 and/or degrading the operational life of chilling unit 24 and/or HVAC system 10. In one example, chilling unit 26 would cool gas propagating along flow path 22 toward output 20 to a temperature of 55° Fahrenheit. From the foregoing description it should be understood that the pre-determined temperature to which the temperature regulation system varies the gas is independent of the magnitude of the desired set point temperature. Rather, it is dependent upon a direction of temperature change established by the desired set point temperature: whether the desired set point temperature seeks to achieve an increase of gas temperature in volume 34 or a decrease of the same.

Referring to both FIGS. 1 and 3, in operation of one embodiment a user establishes a desired set point temperature to a temperature below the temperature of the gases in volume 34, shown as step 100. At step 102, controller 30 would generate a signal to control operation of HVAC system 10 and maximize a flow of gases through output 20 and ensure that any valving elements, such as damper 42 included in VAV box 26, was positioned to maximize the flow of gases therethrough. At step 104 controller 30 would cause chiller 22 to cool the temperatures of gases propagating toward output 20 to approximately 55° Fahrenheit. After a duration of time, in this present example of three minutes, controller 30 would transmit a signal to pump 12 reducing gas flow by approximate 30% at step 106. At step 108, after approximately 10 minutes of establishing gas to be 30% of the maximum flow, controller 30 transmits a signal to establish operation of HVAC system 10 so that gases exiting output 20 would be at the desired set point temperature established at step 100 heating unit 28 would be activated to warm gases sufficiently so that the combined thermal effects of both heating unit 28 and chilling unit 24 would cause gases propagating through output 20 to be proximate to the desired set point temperature an at a normal ventilation rate. The normal ventilation rate is the rate at which HVAC system 10 propagates gases into volume 34 and is calculated based upon square footage of occupancy.

Referring to both FIGS. 1 and 4, were a user to establish a desired set point temperature to a temperature above the temperature of the gases in volume 34, shown as step 200, controller 30 would generate a signal to control operation of HVAC system 10 and minimize a flow of gases through output 20 at step 202. This could be achieved in a number of techniques, dependent upon the design of HVAC system 10. In the present embodiment controller 30 would transmit a signal to damper 42 to close the same, thereby preventing gas from propagating through output 20. At step 204 controller 30 would cause heating unit 28 to increase the temperatures of gases in VAV box 26 propagating toward output 20 to approximately 90° Fahrenheit. After a duration of time, approximately two minutes, controller 30 would cause damper 42 to open thereby allowing a maximum flow of gases to propagate from VAV box 26 through output 20. After five minutes, controller 30 would transmit a signal to pump 12 reducing gas flow by approximate 30% at step 208. At step 210, after approximately 10 minutes of establishing gas to be 30% of the maximum flow, controller 30 transmits a signal to establish operation of HVAC 10 so that gases exiting output 20 would be at the desired set point temperature established at step 200, i.e., chilling unit 24 would be activated to cool gases sufficiently so that the combined thermal effects of both heating unit 28 and chilling unit 24 would cause gases propagating through output 20 to be proximate to the desired set point temperature and at a normal ventilation rate.

Referring to both FIGS. 1 and 5, in the current embodiment controller 30 may be implemented, in part, as a software program that may be included as part of a general processing computer system 44 that may communicate with the components of HVAC system 10 over a network, such as a LAN, MAN or WAN, with an example of the WAN being the Internet. To that end, computer system may communicate of the network using TCP/IP and, at a higher network level, use other common Internet protocols to communicate, such as HTTP, FTP, AFS, WAP, etc. To that end, system 44 may be any computing device capable of interfacing directly or indirectly to the Internet or other network connection, such as desktop personal computer, workstation, laptop, PDA, cell phone, or any wireless access protocol (WAP) enabled device and the like running an HTTP client 46. An example of system 44 includes processor 48, a memory system 50, interface 38 that may include input system 52, and output system 54. Processor 48 may be any combination of one or more processors. Memory system 50 may be any combination of one or more memory devices, volatile, and/or non-volatile memory. A portion of memory system is used to run operating system 52 in which HTTP client 46 executes.

Input system 52 may be any combination of input devices, such as one or more keyboards, keypads, mice, trackballs, scanners, cameras, and/or interfaces to networks. Output system 54 may be any combination of output devices, such as one or more monitors 56, printers (not shown), speaker 58 and/or interfaces to networks. HTTP client 46 allows users to establish different desired temperature set points for HVAC system 10. Examples of HTTP client 46 include various browsing applications, such as Microsoft's Internet Explorer browser, Netscape's Navigator browser, Opera's browser, or a WAP-enabled browser in the case of a cell phone, PDA or other wireless device, or the like. Processor 48 may be any known processor in the art, e.g., the CORE DUO® or the CORE 2 DUO® from Intel Corporation of Santa Clara, Calif. Memory system 50 may includes drive storage (not shown), as well as data and instruction registers (not shown) and volatile and non-volatile memory (not shown).

Computer code for operating HVAC system 10 may preferably be downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Oracle Corporation. In addition, the foregoing description is merely illustrative. Many modifications and/or variations of the disclosed embodiments are considered to be covered by the claimed invention. For example, the instant invention may be employed as part of a HVAC system that includes a heat pump goes. Such an HVAC system includes a compressor, an evaporator, a reversing valve and a fan coil. The fan blows air over a coil that is heated or cooled by expanding or condensing gas, depending on the position of the reversing valve (this determines if you're heating or cooling). Both the fan and the compressor may or may not be variable speed. To provide the gust discussed above the reversing valve employed to either heat or cool, the gas propogating through the HVAC system. The fan is operated accordingly, i.e., it is kicked-on if not already operating or, in the case of variable speed controls the velocity of the fan is established accordingly, e.g., maintained at full angular velocity. Therefore, the scope of the appended claims should be accorded the broadest interpretation so as to encompass all such modifications and similar arrangements.

1. A method of operating an HVAC system having a pump in fluid communication with both a supply of gas and a duct system, having an input and an output and defining a flow path therebetween, a temperature regulation system in thermal communication with said flow path and a controller in electrical communication with said temperature regulation system and said pump, said method comprising:
receiving a request from said control system to varying a temperature of said gas exiting said output;
establishing, with said controller, operation of said pump to maximize a flow rate of said gas propagating through said output into a volume for a first duration of time;
upon expiration of said first duration of time establishing operation of said pump, with said controller, to reduce the flow rate of said gas exiting through said output into said volume to a desired flow rate that is less than said maximum flow rate, with said first duration of time being independent of a temperature of said gas in said volume;
sensing a temperature of said gas in said volume using said controller; and
terminating gas flow through said output in response to said controller sensing said gas in said volume has reached a desired temperature.

2. The method as recited in claim 1 further including minimizing said gas flow through said output in response to said receiving said request to allow said temperature regulation system to vary a temperature of said gas for an interval of time.

3. The method as recited in claim 1 further including minimizing said gas flow through said output in response to said receiving said request to allow said temperature regulation system to vary a temperature of said gas for an interval of time before establishing, with said controller, said operation of said pump to maximize said flow rate.

4. The method as recited in claim 1 wherein receiving further includes providing information to said temperature regulation system to establish a desired temperature set point and establishing further includes transmitting, with said controller, a temperature control signal to cause said temperature regulation system to cool gas propagating toward said output to a pre-determined temperature set point that is lower than said desired temperature set point.

5. The method as recited in claim 1 wherein receiving further includes providing information to said temperature regulation system to establish a desired temperature set point and establishing further includes transmitting, with said controller, a temperature control signal to cause said temperature regulation system to cool to desired pre-determined temperature set point that is lower than said desired temperature set point and further including transmitting with said controller a regulation signal to said temperature regulation system to establish said gas exiting said output to maintain a temperature in said volume proximate to said desired temperature set point.

6. The method as recited in claim 1 wherein receiving further includes providing information to said temperature regulation system to establish a desired temperature set point and establishing further includes transmitting, with said controller, a temperature control signal to cause said temperature regulation system to heat gas propagating toward said output to a pre-determined temperature set point that is greater than said desired temperature set point.

7. The method as recited in claim 1 wherein receiving further includes providing information to said temperature regulation system to establish a desired temperature set point and establishing further includes transmitting, with said controller, a temperature control signal to cause said temperature regulation system to heat gas propagating toward said output to a pre-determined temperature set point that is greater than said desired temperature set point and further including transmitting with said controller a regulation signal to said temperature regulation system to establish said gas exiting said output to maintain a temperature in said volume proximate to said desired temperature set point.

8. The method as recited in claim 1 further including minimizing said gas flow through said output in response to said receiving said request to allow said temperature regulation system to increase a temperature of said gas for an interval of time wherein receiving further includes providing information to said temperature regulation system to establish a desired temperature set point and establishing further includes transmitting, with said controller, a temperature control signal to cause said temperature regulation system to heat gas propagating toward said output to a pre-determined temperature set point that is greater than said desired temperature set point and further including transmitting with said controller a regulation signal to said temperature regulation system to establish said gas exiting said output to maintain a temperature in said volume proximate to said desired temperature set point, with said minimizing occurring before said establishing.

9. A method of operating an HVAC system having a pump in fluid communication with both a supply of gas and a duct system, having an input and an output and defining a flow path therebetween, a temperature regulation system in thermal communication with said flow path and a controller in electrical communication with said temperature regulation system and said pump, said method comprising:
receiving a request from said control system to establish in said volume a desired set point temperature;
transmitting, with said controller, a temperature control signal to cause said temperature regulation system to vary a temperature of gas propagating toward said output to a pre-determined temperature set point that is different from said desired set point temperature, with said pre-determined temperature being independent of the magnitude of the desired set point temperature; and
upon expiration of a pre-determined duration of time, establishing said temperature regulation system to transmit with said controller a regulation signal to said temperature regulation system to establish said gas exiting said output to maintain a temperature in said volume proximate to said desired temperature set point.

10. The method as recited in claim 9 further including before said transmitting, minimizing said gas flow through said output in response to said receiving said request to allow said temperature regulation system to vary a temperature of said gas for an interval of time.

11. The method as recited in claim 10 further including transmitting a signal to said temperature regulation system to increase a temperature of said gas during said interval of time.

12. The method as recited in claim 9 wherein transmitting further includes causing said controller to transmit a temperature control signal to cause said temperature regulation system to reduce a temperature of gas propagating toward said output to a temperature that is lower than said desired set point temperature.

13. The method as recited in claim 9 wherein transmitting further includes causing said controller to transmit a temperature control signal to cause said temperature regulation system to increase a temperature of gas propagating toward said output to a temperature that is greater than said desired set point temperature.

14. An HVAC system for regulating the atmosphere of a volume, said system comprising:
a duct system having an input and an output, defining a flow path therebetween;
a supply of gas in fluid communication with said duct system;
a pump in fluid communication with said duct system;
a temperature regulation system in thermal communication with said flow path; and
a controller in electrical communication with said temperature regulation system and said pump, with said controller having a processor and computer readable memory in data communication with said processor storing instructions when operated on by aid processor to cause said controller to establish operation of said pump to maximize a flow rate of said gas propagating through said output into a volume for a first duration of time in response to receiving a request to varying a temperature of said gas exiting said output; upon expiration of said first duration of time establish operation of said pump, with said controller, to reduce the flow rate of said gas exiting through said output into said volume to a desired flow rate that is less than said maximum flow rate, with said first duration of time being independent of a temperature of said gas in said volume; sense a temperature of said gas in said volume using said controller; and terminate gas flow through said output in response to said controller sensing said gas in said volume has reached a desired temperature.

15. The system as recited in claim 14 wherein said instructions further includes a subroutine when operated on by the processor controls the pump to minimize said gas flow through said output in response to said request to allow said temperature regulation system to vary a temperature of said gas for an interval of time.

16. The system as recited in claim 14 wherein said instructions further includes a subroutine when operated on by the processor controls the pump to minimize said gas flow through said output in response to said receiving said request to allow gas in thermal communication with said temperature regulation system to vary a temperature of said gas for an interval of time before establishing, with said controller, said operation of said pump to maximize said flow rate.

17. The system as recited in claim 14 wherein said instructions further includes a subroutine when operated on by the processor provides information to said temperature regulation system to establish a desired temperature set point and transmits, a temperature control signal to cause said temperature regulation system to cool gas propagating toward said output to a pre-determined temperature set point that is lower than said desired temperature set point.

18. The system as recited in claim 14 wherein said instructions further includes a subroutine when operated on by the processor provides information to said temperature regulation system to establish a desired temperature set point and transmits a temperature control signal and a regulation signal, with said temperature control signal causing said temperature regulation system to cool gas propagating along said flow path to desired pre-determined temperature set point that is lower than said desired temperature set point and said regulation signal causing said temperature regulation system to establish said gas exiting said output to maintain a temperature in said volume proximate to said desired temperature set point.

19. The system as recited in claim 14 wherein said instructions further includes a subroutine when operated on by said processor provides information to said temperature regulation system to establish a desired temperature set point and transmits a temperature control signal to cause said temperature regulation system to heat gas propagating toward said output to a pre-determined temperature set point that is greater than said desired temperature set point.

20. The system as recited in claim 14 wherein said instructions further includes a subroutine when operated on by said processor provides information to said temperature regulation system to establish a desired temperature set point and transmits a temperature control signal and a regulation signal, with said temperature control signal causing said temperature regulation system to heat gas propagating toward said output to a pre-determined temperature set point that is greater than said desired temperature set point and said regulation signal causing said temperature regulation system to establish said gas exiting said output to maintain a temperature in said volume proximate to said desired temperature set point.
